(19) United States
(12) Patent Application Publication
(10) Pub. No.: US 2026/0059198 A1
(43) Pub. Date: Feb. 26, 2026

(54) IMAGE CALIBRATION METHOD AND SURVEILLANCE APPARATUS

(71) Applicant: VIVOTEK INC., New Taipei City (TW)

(72) Inventor: Kuo-Yeh Hsieh, New Taipei City (TW)

(73) Assignee: VIVOTEK INC., New Taipei City (TW)

(21) Appl. No.: 19/292,964

(22) Filed: Aug. 7, 2025

(30) Foreign Application Priority Data
Aug. 20, 2024 (TW) 113131205

(51) Int. Cl. H04N 23/69; H04N 23/60; H04N 23/61

(52) U.S. Cl. CPC H04N 23/69; H04N 23/61; H04N 23/64

(57) ABSTRACT

An image calibration method is used to calibrate position offset between a first image and a second image captured by a surveillance apparatus in different zoom modes. The image calibration method includes acquiring a plurality of first feature points of the first image and a plurality of second feature points of the second image, dividing the plurality of first feature points and the plurality of second feature points at least into a first group and a second group according to distribution density of the plurality of first feature points and the plurality of second feature points, deciding whether the first group corresponds to the second group, and utilizing coordinates of the first group and coordinates of the second group to compute a position shifting value when the first group corresponds to the second group.

### BACKGROUND OF THE INVENTION

### 1. Field of the Invention

The present invention relates to an image calibration method and a surveillance apparatus, and more particularly, to an image calibration method and a related surveillance apparatus of calibrating position offset between images captured in different zoom modes.

### 2. Description of the Prior Art

A conventional surveillance camera is equipped with the optical zoom lens, which can greatly increase the surveillance range of surveillance camera through the zoom function. However, the high-magnification optical zoom lens has strict manufacturing and assembly tolerance conditions; if the manufacturing and assembly accuracy of the optical zoom lens is poor, or there is a displacement error or tilt error of the lens or the image sensor relative to the optical axis of the optical zoom lens, or the lens is displaced due to vibration, the optical zoom lens may have optical axis deviation phenomenon. In order to control the center point of multiple images captured by the optical zoom lens in different zoom modes within the reasonable error, conventional solution increases design, production and manufacturing costs of the optical zoom lens. Therefore, design of an image calibration method that performs optical axis offset correction through software analysis to reduce development and manufacturing costs of the optical zoom lens is an important issue in the related surveillance apparatus industry.

### SUMMARY OF THE INVENTION

The present invention provides an image calibration method and a related surveillance apparatus of calibrating position offset between images captured in different zoom modes for solving above drawbacks.

According to one embodiment, an image calibration method is used to calibrate position offset between a first image and a second image captured by a surveillance apparatus in different zoom modes. The image calibration method includes acquiring a plurality of first feature points of the first image and a plurality of second feature points of the second image, classifying the plurality of first feature points and the plurality of second feature points respectively into at least one first group and at least one second group in accordance with distribution density of the plurality of first feature points and distribution density of the plurality of second feature points, deciding whether the at least one first group is paired with the at least one second group, and utilizing coordinates of the at least one first group and coordinates of the at least one second group to compute a position shifting value for calibrating the position offset between the first image and the second image when the at least one first group is paired with the at least one second group.

According to another embodiment, the surveillance apparatus includes an image receiver and an operation processor. The image receiver is adapted to acquire a first image and a second image captured in different zoom modes. The operation processor is electrically connected to the image receiver, and adapted to acquire a plurality of first feature points of the first image and a plurality of second feature points of the second image, classify the plurality of first feature points and the plurality of second feature points respectively into at least one first group and at least one second group in accordance with distribution density of the plurality of first feature points and distribution density of the plurality of second feature points, decide whether the at least one first group is paired with the at least one second group, and utilize coordinates of the at least one first group and coordinates of the at least one second group to compute a position shifting value for calibrating position offset between the first image and the second image when the at least one first group is paired with the at least one second group.

The image calibration method and the surveillance apparatus of the present invention can use pixel space distance screening technology to determine whether each feature point and the central coordinate of the image produce an excessive pixel displacement result, so as to decide how to remove the pixel displacement data that does not meet the requirement and filter out the representative feature points; then, the present invention can classify the feature points into different groups and perform the group label in accordance with the distribution density, and try to find out the same object in different images; final, the present invention can repair all the groups and all the labels, and find out the correct pairing of the first group and the corresponding second group from the multiple pairing results, so as to utilize the coordinates of the feature points in the correct pairing of the first group and the corresponding second group to compute the position shifting value (of the center point), and calibrate the image position offset between two images sequentially captured in different zoom modes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a surveillance apparatus according to an embodiment of the present invention.

FIG. 2 is a diagram of a first image and a second image captured by the surveillance apparatus according to the embodiment of the present invention.

FIG. 3 is a flow chart of an image calibration method according to the embodiment of the present invention.

FIG. 4 is a diagram of distribution of feature points converted from the first image and the second image according to the embodiment of the present invention.

### DETAILED DESCRIPTION

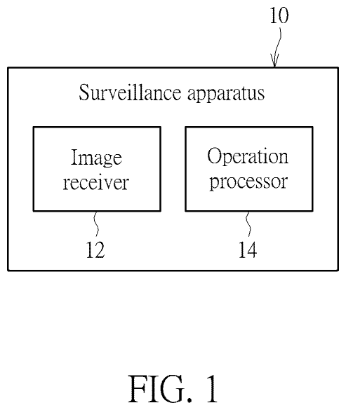

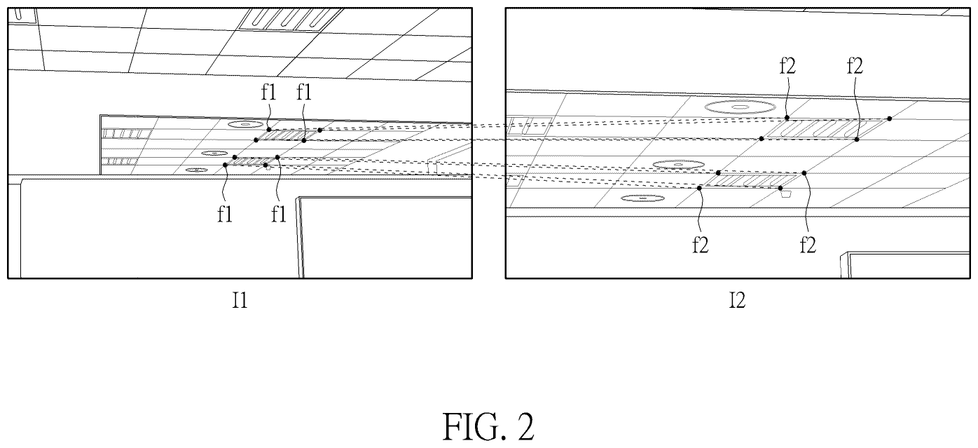

Please refer to FIG. 1 and FIG. 2. FIG. 1 is a functional block diagram of a surveillance apparatus 10 according to an embodiment of the present invention. FIG. 2 is a diagram of a first image I1 and a second image 12 captured by the surveillance apparatus 10 according to the embodiment of the present invention. The surveillance apparatus 10 can be a computation module inside a surveillance camera, or can be applied to a remote server electrically connected to the surveillance camera in a wired manner or in a wireless manner. The surveillance apparatus 10 can include an image receiver 12 and an operation processor 14 electrically connected to each other. The image receiver 12 can acquire the first image I1 and the second image 12 sequentially captured in different zoom modes. The operation processor 14 can analyze and compute a position shifting value between the first image I1 and the second image 12 for subsequent optical axis calibration and/or image position offset calibration.

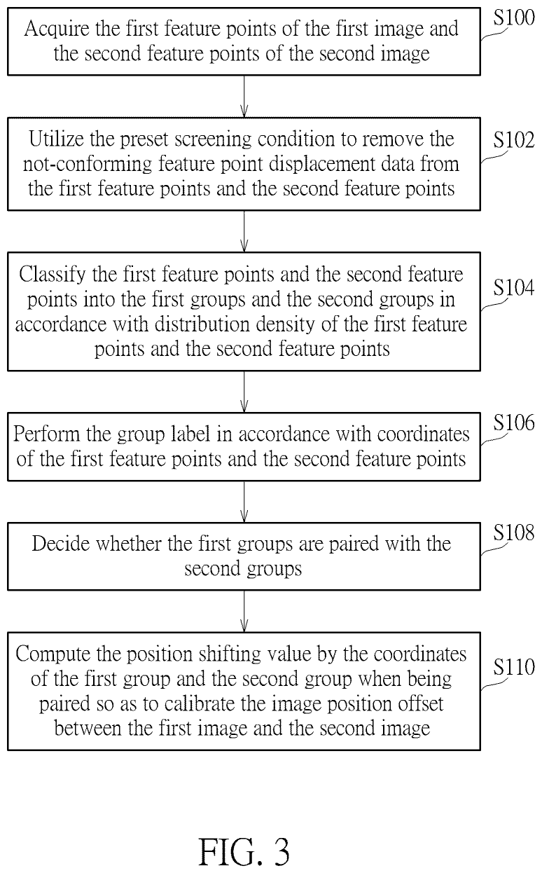

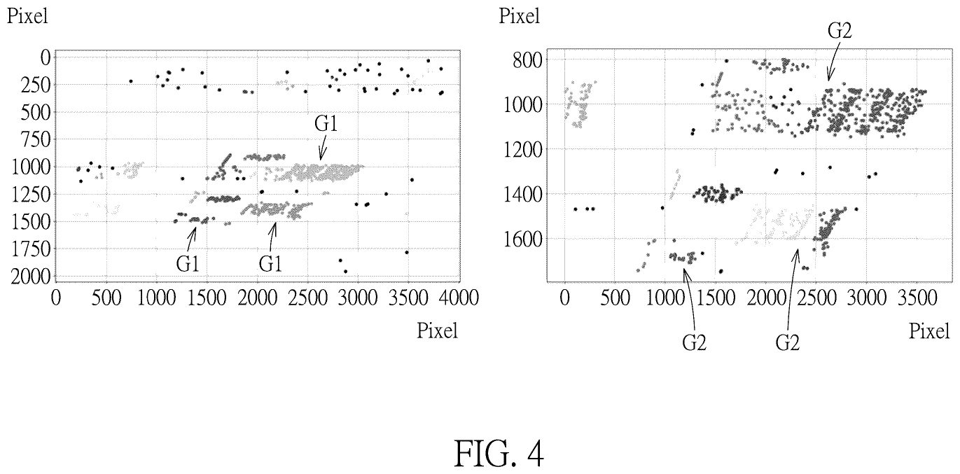

Please refer to FIG. 3 and FIG. 4. FIG. 3 is a flow chart of an image calibration method according to the embodiment of the present invention. FIG. 4 is a diagram of distribution of feature points converted from the first image I1 and the second image 12 according to the embodiment of the present invention. The operation processor 14 of the surveillance apparatus 10 shown in FIG. 1 can execute the image calibration method illustrated in FIG. 3. According to the image calibration method, step S100 can be executed to analyze and acquire a plurality of first feature points f1 of the first image I1 and a plurality of second feature points f2 of the second image 12 by using the common object recognition technology. FIG. 2 only shows some part of the first feature points f1 and the second feature points f2. An actual number and position of the feature points are not limited to the embodiment shown in the figures, and depend on an actual recognition result.

In step S100, if image resolution of the first image I1 and the second image 12 are larger, or if difference between the first image I1 and the second image 12 is low, the number of the plurality of first feature points f1 and the plurality of second feature points f2 are large. The image calibration method of the present invention can optionally filter out the plurality of required first feature points f1 and the plurality of required second feature points f2 respectively from the original first feature points f1 and the original second feature points f2 in accordance with a preset sampling error, so as to reduce computation burden of the surveillance apparatus 10. An actual value and a sample quantity of the preset sampling error can depend on a design demand, and a detailed description is omitted herein for simplicity.

Then, step S102 can be executed to acquire the plurality of first feature points f1 and the plurality of second feature points f2 by optionally using a preset screening condition, so as to remove feature point displacement data that does not conform to the displacement data generated between two images captured after optical zoom, and therefore prevent pairing accuracy of the subsequent feature point from being affected by different fields of view of the first image I1 and the second image 12, as well as interference factors of a moving object, a repeated object, and light and shadow change existed in a surveillance scene of the surveillance apparatus 10. In step S102, the zoom mode of the surveillance apparatus 10 is a known function, and the image calibration method can acquire a normal pixel displacement value of the first image I1 and the second image 12, and compute a maximal optical axis offset in accordance with an optical axis error parameter of the surveillance apparatus 10, and analyze the normal pixel displacement value and the maximal optical axis offset to compute the preset screening condition, as Formula 1, Formula 2, Formula 3 and Formula 4.

$$ratio = \frac{R 2}{R 1} \qquad Formula 1$$

$${NormalOffset}_{i} = \sqrt{{( {x}_{i 1} - {x}_{c} )}^{2} + {( {y}_{i 1} - {y}_{c} )}^{2}} \times ratio \qquad Formula 2$$

$$ErrOffset = \vert \sqrt{{W}^{2} + {H}^{2}} \times tan \frac{{Tol}_{err}}{2} \times ( cot \frac{{DFOV}_{wide}}{2 R 2} - cot \frac{{DFOV}_{wide}}{2 R 1} ) \vert \qquad Formula 3$$

$${MaxOffset}_{i} = {NormalOffset}_{i} + ErrOffset \qquad Formula 4$$

A symbol R1 can be interpreted a zoom factor of the first image I1. A symbol R2 can be interpreted the zoom factor of the second image 12. A symbol “ratio” can be interpreted a zoom ratio of two images. Symbols (x_{c}, y_{c}) can be interpreted central coordinates of the first image I1 and the second image 12. Symbols (xᵢ, yᵢ) can be interpreted feature point coordinates of the first image I1 and/or the second image 12. A symbol “NormalOffsetᵢ” can be interpreted as the normal pixel displacement value generated by the same pair of feature points between the first image I1 and the second image 12. A symbol “W” and a symbol “H” can be interpreted as a width and a height of the first image I1 and/or the second image 12. A symbol “Tolₑᵣᵣ” can be interpreted as an optical axis design and production error angle of a zoom module of the surveillance apparatus 10. A symbol “DFOV_{wide}” can be interpreted as a diagonal viewing angle of the first image I1 (or the second image 12) with a screen magnification of 1.0. A symbol “ErrOffset” can be interpreted as the maximal optical axis offset computed by the foresaid parameters. Final, a symbol “MaxOffset” can be interpreted as a difference between the normal pixel displacement value and the maximal optical axis offset, for indicating the preset screening condition.

When a distance between one first feature point f1 and the paired second feature point f2 is greater than the preset screening condition, it means that the pairing result of the feature points has large pixel displacement and is incorrect, and the pairing result of the feature points can be removed at this stage. When the distance between one first feature point f1 and the paired second feature point f2 is smaller than or equal to the preset screening condition, it means that the pairing result of the feature points does not have large pixel displacement and is correct, so that the pairing result of the first feature point f1 and the corresponding second feature point f2 can be retained.

Then, step S104 and step S106 can be executed to classify the plurality of first feature points f1 and the plurality of second feature points f2 respectively into multiple first groups G1 and multiple second groups G2 in accordance with distribution density of the plurality of first feature points f1 and distribution density of the plurality of second feature points f2, as shown in FIG. 4, and further perform group label on the plurality of first feature points f1 and the plurality of second feature points f2 in accordance with coordinates of the plurality of first feature points f1 and the plurality of second feature points f2 (or a classifying result of the multiple first groups G1 and the multiple second groups G2), for acquiring a label “Label1” and a label “Label2”. A type number of the label “Label1” can be the same as or different from a type number of the label “Label2”. It should be mentioned that the preset screening condition in step S102 can be used after step S104; for example, the preset screening condition can be used to filter out the plurality of first feature points f1 of the first group G1 and the plurality of second feature points f2 of the second group G2, and an actual application of the preset screening condition can depend on the design demand.

In the embodiment of the present invention, the surveillance scene of the surveillance apparatus 10 may contain various types of objects, and a number of objects may be changed at any time, so the image calibration method of the present invention can classify the feature points into multiple groups without presetting the object shape and a number of classifications. If some feature points belong to the same object in the surveillance scene, the feature points may be grouped at a certain density, and a density-based feature point grouping method can be adopted to classify and perform the group label on the features points of the first image I1 and the second image 12. Take the plurality of first feature points f1 and the related multiple first groups G1 as an example, step S104 can set one first feature point f1 of the first group G1 to which the plurality of first feature points f1 belongs as the center, and search for whether a range inside a preset searching radius has other first feature points that meet a preset number, so as to determine whether to classify the said first feature point f1 as the corresponding first group G1 in accordance with a searching result, as Formula 5 and Formula 6.

$${D}_{sort} = sort ( D [ i , : ] ) [ 1 : k + 1 ] \qquad Formula 5$$

$${Density}_{mean} = \frac{1}{m} {\sum }_{i = 0}^{m - 1} {\sum }_{j = 1}^{k} {D}_{sort} [ i , j ] \qquad Formula 6$$

A symbol “Dₛₒᵣₜ” can be interpreted as a distance matrix, and a symbol “Dₛₒᵣₜ[i, j]” can be interpreted as a pixel coordinate distance from a feature point “i” to a feature point “j”. A symbol “k” can be interpreted as a number of the other first feature points f1 that are closest, so that the distribution density (which can be indicated by a symbol “Densityₘₑₐₙ”) can be computed to provide the preset searching radius. That is to say, the image calibration method of the present invention can compute the distribution density and accordingly set the preset searching radius, by using distances between the k neighboring first feature points f1 that are adjacent to the first feature points f1 set as the center. For example, if other first feature points f1 that meet the preset number (e.g., being greater than the preset number) are found within the preset searching radius of the first feature points f1 that is set as the center, the found first feature points f1 can have the same label “Label1” and be regarded as the same first group G1, and then the foresaid other first feature points f1 can be used to continuously search further feature point that can have the same label “Label1” and be classified as the same first group G. If there are no first feature point f1 that meets the preset number (e.g., being smaller than or equal to the preset number) within the preset searching radius of the first feature points f1 set as the center, the first feature points f1 which is set as the center can be classified as noise.

Then, step S108 and step S110 can be executed that the image calibration method of the present invention can decide whether multiple first groups G1 are respectively paired with multiple second groups G2, and utilize coordinates of one first group G1 and coordinates of a corresponding second group G2 to compute a position shifting value when the foresaid first group G1 is paired with the corresponding second group G2. The position shifting value can be used to calibrate image position offset between the first image I1 and the second image 12. In step S108, a plurality of pairing numbers of each of the multiple first groups G1 relative to the multiple second groups G2 can be analyzed to find out a maximal pairing number and further to acquire a correct pairing of the first group G1 and the corresponding second group G2. The maximal pairing number can be preferably greater than or equal to fifty percent of a total count of the plurality of pairing numbers. As shown in Table 1, the maximal pairing number between the 0^{th} label “Label1” and the first column label “Label2” is 9 and greater than fifty percent of the total count of other pairing number, so the 0^{th} label “Label1” and the first column label “Label2” have a pairing result (0:0); other pairing results can refer to Table 1, and the detailed description is omitted herein for simplicity. After acquiring all the pairing results, it can be determined that the pairing results (1:1), (2:3) and (3:5) are consistent in the pairing process of each column and each row, and are considered as the correct pairing results.

TABLE 1

| | Label2 | | | | | | | |
|---|---|---|---|---|---|---|---|---|
| Label1 | 0 | 1 | 2 | 3 | 4 | 5 | 6 | pairing result |
| 0 | 9 | 1 | 0 | 0 | 0 | 0 | 0 | 0:0 |
| 1 | 17 | 272 | 10 | 0 | 5 | 0 | 3 | 1:1 |
| 2 | 0 | 0 | 0 | 6 | 0 | 0 | 0 | 2:3 |
| 3 | 0 | 0 | 0 | 0 | 0 | 3 | 0 | 3:5 |
| 4 | 3 | 0 | 0 | 0 | 0 | 0 | 0 | 4:0 |
| pairing result | 1:0 | 1:1 | 1:2 | 2:3 | 1:4 | 3:5 | 1:6 | |

Besides, the image calibration method of the present invention can preferably use an absolute majority counting manner to extract the most representative group pairing result, but the group pairing result may produce an empty set due to dispersion of the first feature point and/or the second feature point. For example, if there are a lot of moving objects or suddenly appearing shielded objects in the first image I1 and the second image 12, a change trend between the first image I1 and the second image 12 may not be determined due to insufficient feature points. When the group pairing result decided in step S108 belongs to the empty set, step S110 can be omitted; when the group pairing result decided in step S108 does not belong to the empty set, the correct pairing result can be used to execute step S110 for computing the position shifting value (of the center point) and calibrating the image position offset between the first image I1 and the second image 12. It should be mentioned that the preset screening condition in step S102 may be applied after step S108, for example, the preset screening condition can be used to filter the group pairing result; its actual application can depend on the design demand.

In step S110, the image calibration method of the present invention can compute a first shifting value of an average coordinate relative to the central coordinate of the first image I1 in accordance with the correct pairing of the first group G1, and further compute a second shifting value of an average coordinate relative to the central coordinate of the second image 12 in accordance with the correct pairing of the corresponding second group G2, and then compute a zoom ratio of the first image I1 to the second image 12. Final, a product of the first shifting value and the zoom ratio can be computed, and a difference between the second shifting value and the foresaid product can be computed to acquire the position shifting value, as Formula 1, Formula 7, Formula 8 and Formula 9. A symbol “AVG(Key₁)” can be interpreted as the average coordinate of the first feature points f1 in the first image I1. A symbol “AVG(Key₂)” can be interpreted as the average coordinate of the second feature points f2 in the second image 12. The symbol AVG(Key) can be a two-dimensional coordinate point in the form of (x, y), where AVG(Key)[0] can represent its x-axis coordinate value and AVG(Key)[1] can represent its y-axis coordinate value. A symbol “Center” can be interpreted as the central coordinate of two images; accordingly, the symbols Center[0] and Center[1] can respectively represent positions of the central coordinate “Center” on the x-axis and y-axis. Therefore, a symbol “Offset(Key1)” can be interpreted as the first shifting value of the average coordinate relative to the central coordinate of the first image I1, and a symbol “Offset(Key2)” can be interpreted as the second shifting value of the average coordinate relative to the central coordinate of the second image 12. A symbol “Optical Offset” can be interpreted as the position shifting value (of the center point) computed by the first shifting value, the second shifting value and the zoom ratio.

$$Offset ( {Key}_{1} ) = ( AVG ( {Key}_{1} ) [ 0 ] - Center [ 0 ] , AVG ( {Key}_{1} ) [ 1 ] - Center [ 1 ] ) \qquad Formula 7$$

$$Offset ( {Key}_{2} ) = AVG ( {Key}_{2} ) \qquad Formula 8$$

$$OpticalOffset = Offset ( {Key}_{2} ) - Offset ( {Key}_{1} ) \times ratio \qquad Formula 9$$

In conclusion, the image calibration method and the surveillance apparatus of the present invention can use pixel space distance screening technology to determine whether each feature point and the central coordinate of the image produce an excessive pixel displacement result, so as to decide how to remove the pixel displacement data that does not meet the requirement and filter out the representative feature points; then, the present invention can classify the feature points into different groups and perform the group label in accordance with the distribution density, and try to find out the same object in different images; final, the present invention can repair all the groups and all the labels, and find out the correct pairing of the first group and the corresponding second group from the multiple pairing results, so as to utilize the coordinates of the feature points in the correct pairing of the first group and the corresponding second group to compute the position shifting value (of the center point), and calibrate the image position offset between two images sequentially captured in different zoom modes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image calibration method of calibrating position offset between a first image and a second image captured by a surveillance apparatus in different zoom modes, the image calibration method comprising:
an operation processor of the surveillance apparatus acquiring a plurality of first feature points of the first image and a plurality of second feature points of the second image;
the operation processor classifying the plurality of first feature points and the plurality of second feature points respectively into at least one first group and at least one second group in accordance with distribution density of the plurality of first feature points and distribution density of the plurality of second feature points;
the operation processor deciding whether the at least one first group is paired with the at least one second group; and
the operation processor utilizing coordinates of the at least one first group and coordinates of the at least one second group to compute a position shifting value for calibrating the position offset between the first image and the second image when the at least one first group is paired with the at least one second group.

2. The image calibration method of claim 1, further comprising:
the operation processor acquiring the plurality of first feature points and the plurality of second feature points by a preset screening condition, or filtering the plurality of first feature points of the at least one first group and the plurality of second feature points of the at least one second group by the preset screening condition.

3. The image calibration method of claim 2, further comprising:
the operation processor acquiring a normal pixel displacement value of the first image and the second image;
the operation processor computing a maximal optical axis offset in accordance with an optical axis error parameter of the surveillance apparatus; and
the operation processor analyzing the normal pixel displacement value and the maximal optical axis offset to compute the preset screening condition.

4. The image calibration method of claim 1, further comprising:
the operation processor performing group label on the plurality of first feature points in accordance with coordinates of the plurality of first feature points, and further performing group label on the plurality of second feature points in accordance with coordinates of the plurality of second feature points.

5. The image calibration method of claim 1, wherein the plurality of first feature points comprises multiple first groups, and the plurality of second feature points comprises multiple second groups, the image calibration method further comprises:
the operation processor utilizing a preset searching radius to search for other first feature points that meet a preset number, based on a center defined by one of the first feature points in the group belonging to the plurality of first feature points; and
the operation processor determining whether the one of the first feature points is classified as a corresponding first group of the multiple first groups in accordance with a searching result.

6. The image calibration method of claim 5, further comprising:
the operation processor computing the distribution density to set the preset searching radius by using a distance between k first feature points that are adjacent to the one of the first feature points.

7. The image calibration method of claim 1, further comprising:
the operation processor analyzing a plurality of pairing numbers of each of multiple first groups relative to multiple second groups; and
the operation processor finding a maximal pairing number from the plurality of pairing numbers to acquire a correct pairing of a first group and a corresponding second group.

8. The image calibration method of claim 7, wherein the maximal pairing number is greater than fifty percent of a total count of the plurality of pairing numbers.

9. The image calibration method of claim 7, further comprising:
the operation processor computing a first shifting value of an average coordinate of the first image relative to a central coordinate in accordance with the correct pairing of the first group;
the operation processor computing a second shifting value of an average coordinate of the second image relative to the central coordinate in accordance with the correct pairing of the corresponding second group;
the operation processor computing a zoom ratio of the first image to the second image; and
the operation processor analyzing the first shifting value, the second shifting value and the zoom ratio to acquire the position shifting value.

10. A surveillance apparatus, comprising:
an image receiver adapted to acquire a first image and a second image captured in different zoom modes; and
an operation processor electrically connected to the image receiver, and adapted to acquire a plurality of first feature points of the first image and a plurality of second feature points of the second image, classify the plurality of first feature points and the plurality of second feature points respectively into at least one first group and at least one second group in accordance with distribution density of the plurality of first feature points and distribution density of the plurality of second feature points, decide whether the at least one first group is paired with the at least one second group, and utilize coordinates of the at least one first group and coordinates of the at least one second group to compute a position shifting value for calibrating position offset between the first image and the second image when the at least one first group is paired with the at least one second group.

11. The surveillance apparatus of claim 10, wherein the operation processor is adapted to further acquire the plurality of first feature points and the plurality of second feature points by a preset screening condition, or filtering the plurality of first feature points of the at least one first group and the plurality of second feature points of the at least one second group by the preset screening condition.

12. The surveillance apparatus of claim 11, wherein the operation processor is adapted to further acquire a normal pixel displacement value of the first image and the second image, compute a maximal optical axis offset in accordance with an optical axis error parameter of the surveillance apparatus, and analyze the normal pixel displacement value and the maximal optical axis offset to compute the preset screening condition.

13. The surveillance apparatus of claim 10, wherein the operation processor is adapted to further perform group label on the plurality of first feature points in accordance with coordinates of the plurality of first feature points, and perform group label on the plurality of second feature points in accordance with coordinates of the plurality of second feature points.

14. The surveillance apparatus of claim 10, wherein the plurality of first feature points comprises multiple first groups, the plurality of second feature points comprises multiple second groups, the operation processor is adapted to further utilize a preset searching radius to search for other first feature points that meet a preset number based on a center defined by one of the first feature points in the group belonging to the plurality of first feature points, and determine whether the one of the first feature points is classified as a corresponding first group of the multiple first groups in accordance with a searching result.

15. The surveillance apparatus of claim 14, wherein the operation processor is adapted to further compute the distribution density to set the preset searching radius by using a distance between k first feature points that are adjacent to the one of the first feature points.

16. The surveillance apparatus of claim 10, wherein the operation processor is adapted to further analyze a plurality of pairing numbers of each of multiple first groups relative to multiple second groups, and find a maximal pairing number from the plurality of pairing numbers to acquire a correct pairing of a first group and a corresponding second group.

17. The surveillance apparatus of claim 16, wherein the maximal pairing number is greater than fifty percent of a total count of the plurality of pairing numbers.

18. The surveillance apparatus of claim 16, wherein the operation processor is adapted to further compute a first shifting value of an average coordinate of the first image relative to a central coordinate in accordance with the correct pairing of the first group, compute a second shifting value of an average coordinate of the second image relative to the central coordinate in accordance with the correct pairing of the corresponding second group, compute a zoom ratio of the first image to the second image, and analyze the first shifting value, the second shifting value and the zoom ratio to acquire the position shifting value.
